(19) United States
(12) Patent Application Publication
(10) Pub. No.: US 2025/0041880 A1
(43) Pub. Date: Feb. 6, 2025

(54) LIQUID OUTLET DEVICE AND LIQUID OUTLET SYSTEM

(71) Applicant: FUJIAN XIHE SANITARY WARE TECHNOLOGY CO., LTD, Fujian (CN)

(72) Inventors: Xiaofa LIN, Fujian (CN); Xiaoshan LIN, Fujian (CN); Zhennan CHEN, Fujian (CN); Feiming DENG, Fujian (CN); Xiaoqing DENG, Fujian (CN); Qiqiao LIU, Fujian (CN)

(73) Assignee: FUJIAN XIHE SANITARY WARE TECHNOLOGY CO., LTD, Fujian (CN)

(21) Appl. No.: 18/393,243

(22) Filed: Dec. 21, 2023

(30) Foreign Application Priority Data
Aug. 4, 2023 (CN) 202310979752.6

(51) Int. Cl. B05B 1/30; B05B 1/18

(52) U.S. Cl. CPC B05B 1/3006; B05B 1/18

(57) ABSTRACT

A liquid outlet device and a liquid outlet system are provided. The liquid outlet device includes an outer housing assembly provided with a liquid inlet flow channel and a liquid outlet member installed to the outer housing assembly. The liquid inlet flow channel can form a liquid discharge opening on the outer housing assembly. The liquid outlet member can be enclosed with the outer housing assembly to form a liquid outlet flow channel. A protrusion part of the liquid outlet member can elastically abut against the outer housing assembly, and seal the liquid discharge opening disposed opposite to the protrusion part, so that the liquid can act positively on the protrusion part under the action that the liquid pressure of the liquid inlet flow channel exceeds a preset value. The protrusion part can further reset against the liquid pressure less than or equal to the preset value.

### CROSS-REFERENCE TO RELATED APPLICATION

This application claims foreign priority benefits under 35 U.S.C. § 119 (a)-(d) to Chinese patent application No. 202310979752.6 filed on Aug. 4, 2023, which is hereby incorporated herein by reference in its entirety.

### TECHNICAL FIELD

The present application relates to, but is not limited to, kitchen and bathroom technologies, in particular to a liquid outlet device and a liquid outlet system.

### BACKGROUND

After liquid discharge of an existing liquid outlet device is closed, residual liquid in the liquid outlet device may still be discharged from a liquid outlet opening, which affects the user experience.

### SUMMARY

The present application provides a liquid outlet device and a liquid outlet system, aiming at solving a technical problem that the residual liquid in the liquid outlet device may still be discharged from the liquid outlet opening after the liquid discharge of the existing liquid outlet device is closed.

To achieve the above objects, the present application provides a liquid outlet device including an outer housing assembly and a liquid outlet member. The outer housing assembly is provided with a liquid inlet flow channel, and the liquid inlet flow channel is capable of forming a liquid discharge opening on the outer housing assembly. The liquid outlet member is installed to the outer housing assembly, the outer housing assembly is enclosed with the liquid outlet member to form a liquid outlet flow channel, the liquid outlet opening communicated with the liquid outlet flow channel is provided on the liquid outlet member, and the liquid outlet opening is exposed to the outer housing assembly. The liquid outlet member is provided with a protrusion part, the outer housing assembly is capable of clamping and holding a circumferential outer side of the protrusion part, and the protrusion part is disposed opposite to the liquid discharge opening and elastically abuts against the outer housing assembly to seal the liquid discharge opening. The protrusion part is configured to elastically deform when a liquid pressure of the liquid inlet flow channel exceeds a preset value, so that the liquid discharge opening communicates with the liquid outlet flow channel. The protrusion part is capable of resetting against the liquid pressure less than or equal to the preset value.

In some embodiments of the liquid outlet device, a cavity is provided on a side of the protrusion part facing away from the liquid discharge opening.

In some embodiments of the liquid outlet device, the outer housing assembly is provided with an accommodation groove. The liquid outlet flow channel is communicated with the accommodation groove. The protrusion part is at least partially accommodated in the accommodation groove. The protrusion part is configured to be elastically deformed when the liquid pressure of the liquid inlet flow channel exceeds the preset value, so that the liquid discharge opening is communicated with the accommodation groove.

In some embodiments of the liquid outlet device, the protrusion part is at least partially accommodated in the liquid discharge opening.

In some embodiments of the liquid outlet device, the liquid outlet flow channel is communicated with the cavity.

In some embodiments of the liquid outlet device, multiple liquid outlet flow channels are provided, the multiple liquid outlet flow channels are provided around the protrusion part. Multiple liquid outlet openings are provided, and each of the liquid outlet flow channels is communicated at least with one of the liquid outlet openings.

In some embodiments of the liquid outlet device, a side of the protrusion part facing the liquid discharge opening has a guide surface, and the guide surface is configured to be capable of being elastically deformed with the protrusion part to guide the liquid to the liquid outlet flow channel.

In some embodiments of the liquid outlet device, the guide surface is a spherical crown.

In some embodiments of the liquid outlet device, the protrusion part includes a circumferential wall and a connection wall, the circumferential wall is bent toward the connection wall and is connected to a periphery of the connection wall to form the guide surface on a side of the circumferential wall facing away from the connection wall.

In some embodiments of the liquid outlet device, the circumferential wall is capable of being enclosed with the connection wall to form a groove, and the groove is disposed opposite to the liquid discharge opening.

In some embodiments of the liquid outlet device, the liquid outlet member is made of an elastic material, and the outer housing assembly is capable of clamping and holding the liquid outlet member from a side of the liquid outlet member facing the liquid outlet flow channel and a side of the liquid outlet member facing away from the liquid outlet flow channel, and the side of the liquid outlet member facing the liquid outlet flow channel fits with the outer housing assembly.

In some embodiments of the liquid outlet device, the liquid outlet flow channel extends at least partially away from a radial direction of the liquid outlet member.

To achieve the above objects, the present application also provides a liquid outlet system including: the liquid outlet device as described above; and a liquid inlet assembly communicated with the liquid inlet flow channel. The liquid inlet assembly is configured to provide liquid to the liquid inlet flow channel.

The implementation of embodiments of the present application will have the following beneficial effects.

The liquid outlet device of the above solutions is applied to and equipped in the liquid outlet system, which not only makes the liquid outlet system have excellent cleaning efficiency, but also can avoid residual liquid from being discharged from the liquid outlet opening after the liquid outlet device closes the liquid discharge, thus improving the user experience. Specifically, the liquid outlet device includes an outer housing assembly provided with a liquid inlet flow channel and a liquid outlet member installed to the outer housing assembly. The liquid inlet flow channel can form a liquid discharge opening on the outer housing assembly. The liquid outlet member can be enclosed with the outer housing assembly to form a liquid outlet flow channel and is provided with a liquid outlet opening communicated with the liquid outlet flow channel. The liquid outlet member is provided with a protrusion part. The protrusion part can be elastically abutted against the outer housing assembly, and seal the liquid discharge opening disposed opposite to the protrusion part, so that the liquid can act positively on the protrusion part under the action that the liquid pressure of the liquid inlet flow channel exceeds the preset value, thus ensuring the uniformity of elastic deformation of the protrusion part, ensuring the synchronization of elastic deformation of each portion of the protrusion part, and avoiding the protrusion part from being unable to reset due to too large local deformation. The protrusion part can further reset against the liquid pressure less than or equal to the preset value (e.g., when the liquid outlet device closes the liquid discharge), so as to ensure the scaling of the liquid discharge opening and avoid the liquid remaining in the liquid inlet flow channel from being discharged from the liquid discharge opening and into the liquid outlet flow channel. At the same time, the liquid remaining in the liquid outlet flow channel and the liquid outlet opening cannot be discharged from the liquid outlet opening under an action of atmospheric pressure, self-adsorption, shapes of the liquid outlet flow channel and the liquid outlet opening, etc., so that the residual liquid cannot be discharged from the liquid outlet opening after the liquid outlet device closes the liquid discharge, and the user experience is improved. The circumferential outer side of the protrusion part is clamped and hold by the outer housing assembly, which ensures the position accuracy of the protrusion part in the processes of elastic deformation and reset, and further ensures that the elastic deformation and reset can be stably carried out.

Other features and advantages of the present application will be set forth in the description which follows, and in part will be obvious from the description, or may be learned by practice of the present application. Other advantages of the present application may be realized and attained by the solutions described in the description as well as the drawings.

### BRIEF DESCRIPTION OF THE DRAWINGS

The accompanying drawings are used to provide an understanding of the technical solutions of the present application, and constitute a part of the specification. Together with the embodiments of the present application, they are used to explain the technical solutions of the present application and do not constitute a limitation on the technical solutions of the present application.

FIG. 1 is a schematic diagram of a liquid outlet device in an embodiment of the present application;

FIG. 2 is a schematic exploded diagram of a structure of a liquid outlet device in an embodiment of the present application;

FIG. 3 is a sectional view of a liquid outlet device in an embodiment of the present application;

FIG. 4 is an enlarged schematic diagram of a structure of Part A in FIG. 3;

FIG. 5 is an enlarged schematic diagram of a structure of Part B in FIG. 3;

FIG. 6 is a schematic diagram of a liquid outlet member in a liquid outlet device in an embodiment of the present application; and

FIG. 7 is a partial sectional view of a liquid outlet device in another embodiment of the present application.

### DESCRIPTION OF REFERENCE NUMBERS

10—outer housing assembly, 11—body, 111—face cover, 112—rear housing, 113—inner bracket, 12—ball head, 13—ball head sleeve, 14—nut, 15—gasket, 16—sealing member, 17—flow limiting sheet, 20—liquid outlet member, 21—liquid outlet part, 30—protrusion part, 31—guide surface, 32—circumferential wall, 33—connection wall, 100—liquid inlet flow channel, 101—liquid discharge opening, 200—liquid outlet flow channel, 300—liquid outlet opening, 400—cavity, 500—accommodation groove, 600—notch, 700—mounting space, 800—mounting hole, 900—liquid guide groove.

The realization of the object, functional features and advantages of the present application are further explained with reference to the accompanying drawings in connection with the embodiments.

### DETAILED DESCRIPTION

The present application describes multiple embodiments, but the description is exemplary rather than limiting, and it will be obvious to those of ordinary skills in the art that more embodiments and implementations may be included within the scope of the embodiments described by the present application. Although many possible combinations of features are shown in the drawings and discussed in the detailed description, many other combinations of the disclosed features are also possible. Unless specifically limited, any feature or element of any embodiment may be used in combination with, or substituted for, any other feature or element of any other embodiment.

The present application includes and contemplates combinations with features and elements known to those of ordinary skills in the art. The disclosed embodiments, features, and elements of the present application may also be combined with any conventional features or elements to form a unique inventive solution as defined by the claims. Any feature or element of any embodiment may also be combined with feature(s) or element(s) from other inventive solution to form another unique inventive solution as defined by the claims. Accordingly, it should be understood that any of the features shown and/or discussed in the present application may be implemented alone or in any suitable combination. Thus, the embodiments are not subjected to limitations other than those made in accordance with the appended claims and their equivalent substitutions. In addition, various modifications and changes may be made within the protection scope of the appended claims.

Furthermore, when describing representative embodiments, the specification may have presented a method and/or process as a particular sequence of steps. However, to the extent that the method or process does not depend on the specific order of steps described by the present application, the method or process should not be limited to the specific order of steps described. As will be understood by those of ordinary skill in the art, other order of steps is also possible. Accordingly, the particular order of steps set forth in the specification should not be construed as limitations on the claims. Furthermore, the claims for the method and/or process should not be limited to the steps which are performed in the written order. Those skilled in the art can readily understand that these orders can be changed and still remain within the spirit and scope of the embodiments of the present application.

After the existing liquid outlet device is closed, the residual liquid in the liquid outlet device will still be discharged from the liquid outlet opening, which affects the user experience.

In order to solve the above technical problems, the embodiments of the present application provide a liquid outlet device and a liquid outlet system. The liquid outlet system can be installed in various occasions and environments, such as companies, schools, families, factories and the like to realize cleaning treatment of articles to be cleaned, so as to improve and enhance life quality and health of people. The liquid outlet device can be, but is not limited to, a faucet, a shower or a spray gun. For the convenience of describing the technical solutions of the present application, the following takes the liquid outlet device as an example for illustration.

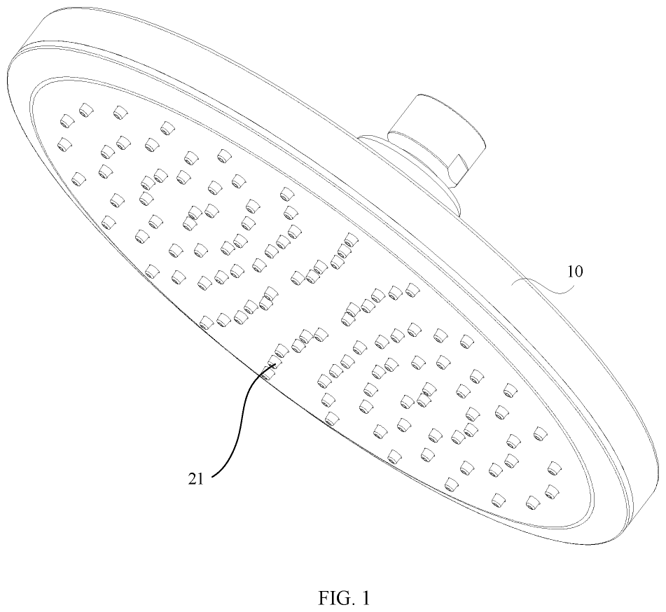

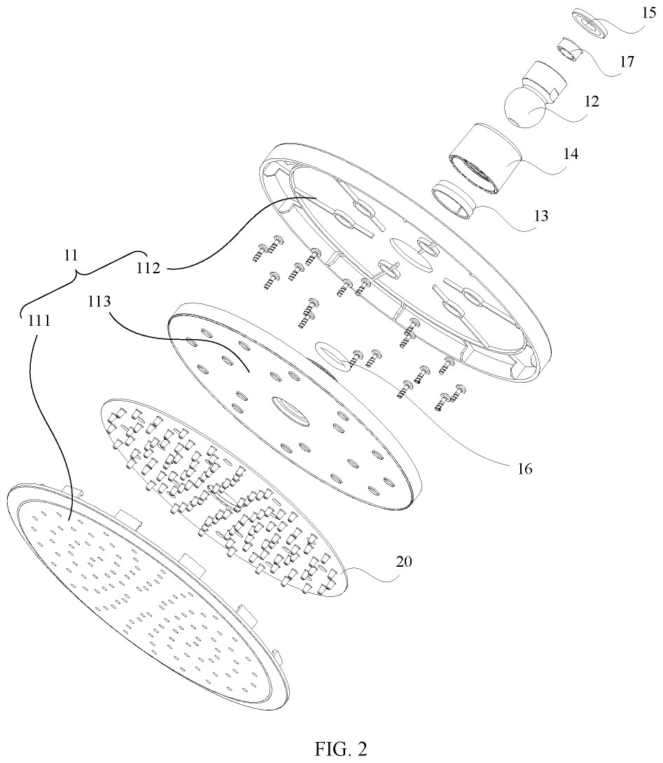

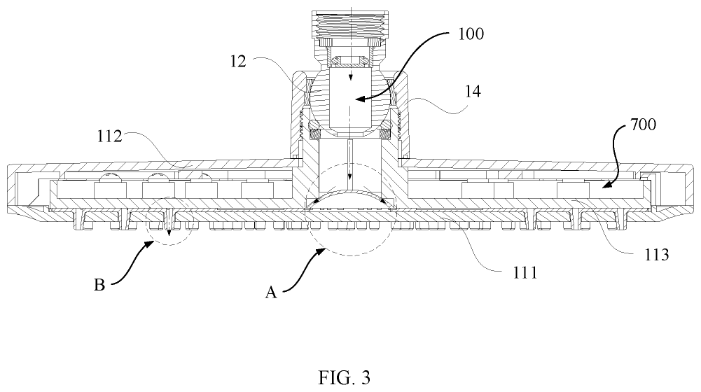

References are made to FIGS. 1-6 together to explain the liquid outlet system provided by embodiments of the present application. The liquid outlet system includes a liquid outlet device and a liquid inlet assembly.

The liquid outlet device includes an outer housing assembly 10 and a liquid outlet member 20. The outer housing assembly 10 is provided with a liquid inlet flow channel 100. The liquid inlet flow channel 100 can form a liquid discharge opening 101 on the outer housing assembly 10.

The liquid outlet member 20 is mounted to the outer housing assembly 10. The outer housing assembly 10 is enclosed with the liquid outlet member 20 to form a liquid outlet flow channel 200. The liquid outlet member 20 is provided with a liquid outlet opening 300 communicated with the liquid outlet flow channel 200. The liquid outlet opening 300 is exposed to the outer housing assembly 10. The liquid outlet member 20 is provided with a protrusion part 30. The outer housing assembly 10 can clamp and hold the circumferential outer side of the protrusion part 30. The protrusion part 30 is disposed opposite to the liquid discharge opening 101 and elastically abuts against the outer housing assembly 10 to seal the liquid discharge opening 101. The protrusion part 30 is provided to elastically deform when the liquid pressure of the liquid inlet flow channel 100 exceeds a preset value, so that the liquid discharge opening 101 communicates with the liquid outlet flow channel 200. The protrusion part 30 can reset against the liquid pressure less than or equal to the preset value.

The liquid inlet assembly is communicated with the liquid inlet flow channel 100 and is configured to provide liquid to the liquid inlet flow channel 100. The liquid inlet assembly may be, but is not limited to, a manually controlled or an electrically controlled valve configuration, and the liquid inlet flow channel 100 is communicated with or disconnected from a liquid source by opening or closing the liquid inlet assembly. The liquid includes, but is not limited to, clear water or pure water from a municipal water network.

The preset value can be set to satisfy that the liquid discharge opening 101 is communicated with the liquid outlet flow channel 200 under certain conditions, and the liquid discharge opening 101 is disconnected from the liquid outlet flow channel 200 under certain conditions. In an embodiment of the present application, the preset value may be set to be less than the liquid pressure when the liquid inlet assembly is opened to supply liquid to the liquid inlet flow channel 100 and greater than the liquid pressure generated by the liquid remaining in the liquid inlet flow channel 100 after the liquid inlet assembly is closed. That is, the liquid drives the protrusion part 30 to elastically deform after the liquid outlet device is turned on for liquid discharge, so that the liquid discharge opening 101 communicates with the liquid outlet flow channel 200; and the protrusion part 30 is reset after the liquid discharge of the liquid outlet device is closed, so as to ensure the sealing of the liquid discharge opening 101 and prevent the liquid remaining in the liquid inlet flow channel 100 from being discharged from the liquid discharge opening 101 and into the liquid outlet flow channel 200.

To sum up, an implementation of an embodiment of the present application will have the following beneficial effects: the liquid outlet device of the above solutions is applied to and equipped in the liquid outlet system, which not only makes the liquid outlet system have excellent cleaning efficiency, but also can prevent residual liquid from being discharged from the liquid outlet opening 300 after the liquid discharge of the liquid outlet device is closed, thus improving the user experience. Specifically, the liquid outlet device includes the outer housing assembly 10 provided with the liquid inlet flow channel 100 and the liquid outlet member 20 mounted to the outer housing assembly 10. The liquid inlet flow channel 100 can form the liquid discharge opening 101 on the outer housing assembly 10. The liquid outlet member 20 can be enclosed with the outer housing assembly 10 to form the liquid outlet flow channel 200 and is provided with the liquid outlet opening 300 communicated with the liquid outlet flow channel 200. The liquid outlet member 20 is provided with the protrusion part 30. The protrusion part 30 can be elastically abutted against the outer housing assembly 10 to seal the liquid discharge opening 101 disposed opposite to the protrusion part 30, so that the liquid can act positively on the protrusion part 30 when the liquid pressure of the liquid inlet flow channel 100 exceeds the preset value, thus ensuring the uniformity of clastic deformation of the protrusion part 30, ensuring the synchronization of clastic deformation of each portion of the protrusion part 30, and avoiding the protrusion part 30 from being unable to reset due to excessive local deformation. The protrusion part 30 can reset against a liquid pressure less than or equal to the preset value (for example, when the liquid discharge of the liquid outlet device is closed), thereby ensuring the sealing of the liquid discharge opening 101 and preventing the liquid remaining in the liquid inlet flow channel 100 from being discharged from the liquid discharge opening 101 and into the liquid outlet flow channel 200. At the same time, the liquid remaining in the liquid outlet flow channel 200 and the liquid outlet opening 300 cannot be discharged from the liquid outlet opening 300 under an action of atmospheric pressure, a self-adsorption capacity, shapes of the liquid outlet flow channel 200 and the liquid outlet opening 300, etc., so that the residual liquid cannot be discharged from the liquid outlet opening 300 after the liquid discharge of the liquid outlet device is closed, and the user experience is improved. The circumferential outer side of the protrusion part 30 is clamped and hold by the outer housing assembly 10, thereby ensuring the position accuracy of the protrusion part 30 during the elastic deformation and reset processes, and further ensuring that the elastic deformation and reset can be stably performed.

In an exemplary embodiment, combined with FIGS. 1-3 together, the outer housing assembly 10 includes a body 11, a ball head 12, a ball head sleeve 13, and a nut 14. A liquid inlet flow channel 100 penetrates through the ball head 12 and extends to the body 11, forming a liquid discharge opening 101 on the body 11. The liquid outlet member 20 is mounted to the body 11, and the body 11 is enclosed with the liquid outlet member 20 to form the liquid outlet flow channel 200. The nut 14 is in threaded connection with the body 11 to press the ball head 12 on the body 11 through the ball head sleeve 13, so as to restrict the movement of the ball head 12 relative to the body 11. Meanwhile, the ball head 12 is attached to the arc-shaped surface of the ball head sleeve 13 to facilitate the rotation of the ball head 12 relative to the body 11, so as to adjust the position of the body 11 and further adjust the direction of liquid discharge. In order to reduce the wear when the ball head 12 rotates relative to the body 11, a gasket 15 is further provided between the ball head 12 and the body 11. At the same time, a sealing member 16 is further provided between the gasket 15, the body 11, and the ball head 12, to prevent liquid from being discharged from the body 11 between the body 11 and the ball head 12. In order to save water resources, a flow limiting sheet 17 is further provided in the liquid inlet flow channel 100 to keep the liquid outlet amount of the liquid outlet device constant and save the liquid consumption.

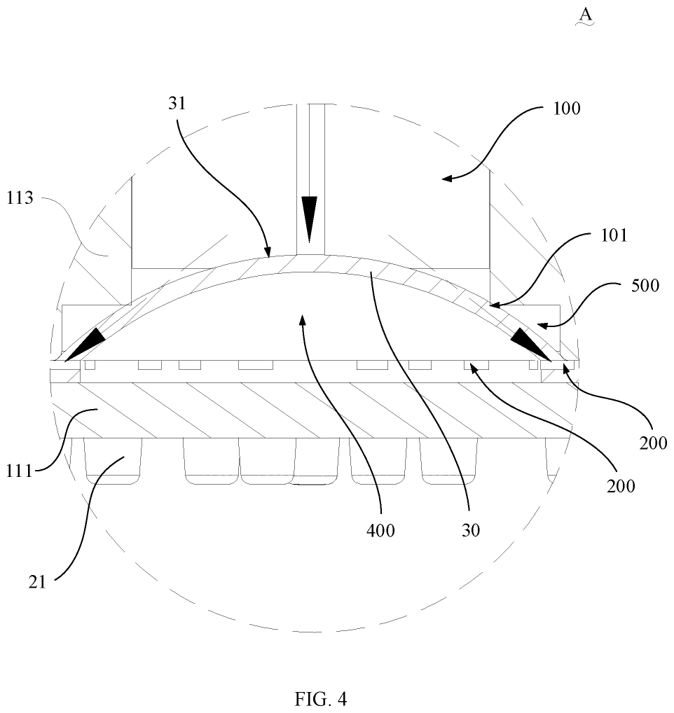

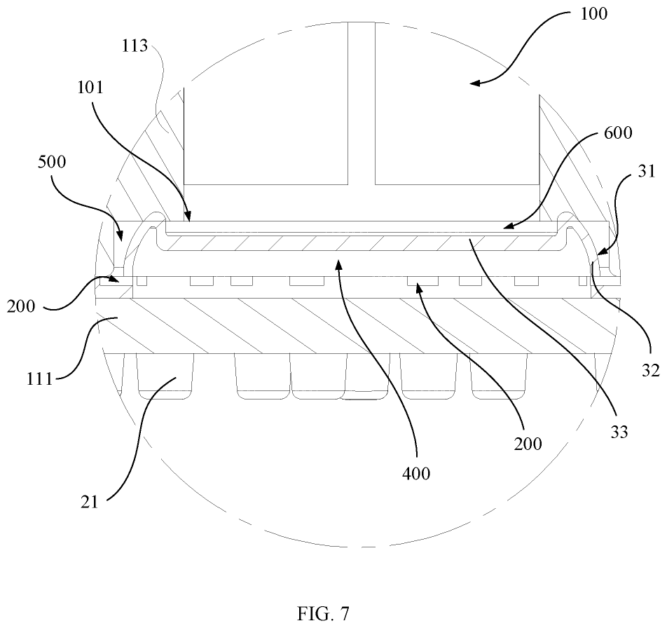

In an exemplary embodiment, combined with FIG. 4 and FIG. 7 together, a side of the protrusion part 30 facing away from the liquid discharge opening 101 has a cavity 400. Thus, the arrangement of the cavity 400 can increase the elastic deformation of the protrusion part 30 generated when the liquid pressure of the liquid inlet flow channel 100 exceeds the preset value, thereby ensuring the connectivity between the liquid discharge opening 101 and the liquid outlet flow channel 200. In addition, in some exemplary embodiments, the protrusion part 30 may also be a solid structure that elastically deforms when the liquid pressure of the liquid inlet flow channel 100 exceeds the preset value by using its own elastic deformation capability. It is to be understood that in other embodiments a reset member may also be provided in the cavity 400 to enhance a reset performance of the protrusion part 30. The reset member can be a spring or an clastic structure made of other elastic materials. The clastic deformation ability of the protrusion part 30 can be adjusted by changing parameters, such as its material and size.

In an exemplary embodiment, with continued reference to FIG. 4 and FIG. 7, the outer housing assembly 10 is provided with an accommodation groove 500. The liquid outlet flow channel 200 is communicated with the accommodation groove 500. The protrusion part 30 is at least partially accommodated in the accommodation groove 500. The protrusion part 30 is configured to be elastically deformed when the liquid pressure of the liquid inlet flow channel 100 exceeds the preset value, so as to communicate the liquid discharge opening 101 with the accommodation groove 500. In this way, by the arrangement of the accommodation groove 500, at least a portion of the protrusion part 30 can be accommodated by the accommodation groove 500, so that during the elastic deformation and reset of the protrusion part 30, the accommodation groove 500 plays a limiting and guiding role to ensure that the elastic deformation and reset can be achieved as desired, thereby ensuring that the liquid discharge opening 101 and the liquid outlet flow channel 200 can communicate with each other after the elastic deformation of the protrusion part 30, and ensuring that the liquid discharge opening 101 can be sealed after the protrusion part 30 is reset.

In an exemplary embodiment, as shown in FIG. 4, the protrusion part 30 is at least partially accommodated in the liquid discharge opening 101 to further enhance the sealing of the protrusion part 30 to the liquid discharge opening 101. The liquid discharge opening 101 also can play a limiting and guiding role for the protrusion part 30, ensuring that the elastic deformation and reset of the protrusion part 30 can meet expectations during the elastic deformation and reset of the protrusion part 30. Meanwhile, the protrusion part 30 is at least partially accommodated in the liquid discharge opening 101, so that a gap is easily generated between the protrusion part 30 and the outer housing assembly 10 after the protrusion part 30 is elastically deformed, so as to facilitate rapid communication between the liquid discharge opening 101 and the liquid outlet flow channel 200.

In an exemplary embodiment, referring to FIG. 4 and FIG. 7 together, the liquid outlet flow channel 200 is communicated with the cavity 400, so that when the protrusion part 30 is elastically deformed, the air in the cavity 400 can be discharged through the liquid outlet flow channel 200, which facilitates the clastic deformation of the protrusion part 30 and ensures smooth communication between the liquid discharge opening 101 and the liquid outlet flow channel 200. After the liquid outlet device is closed, the liquid pressure of the liquid inlet flow channel 100 is less than or equal to the preset value, the protrusion part 30 resets, and the air in the liquid outlet flow channel 200 enters the cavity 400 under the action of atmospheric pressure, so as to ensure that the protrusion part 30 can be completely reset. At the same time, after the air in the liquid outlet flow channel 200 enters the cavity 400, the external air may replenish into the liquid outlet flow channel 200 through the liquid outlet opening 300, and at the same time, the liquid remaining in the liquid outlet opening 300 and the liquid outlet flow channel 200 is pushed to flow toward a side away from the liquid outlet opening 300, thus further preventing the residual liquid from being discharged from the liquid outlet opening 300. In addition, the communication between the liquid outlet flow channel 200 and the cavity 400 can prevent excessive pressure in the cavity 400 from damaging the stability of the connection between the outer housing assembly 10 and the liquid outlet member 20.

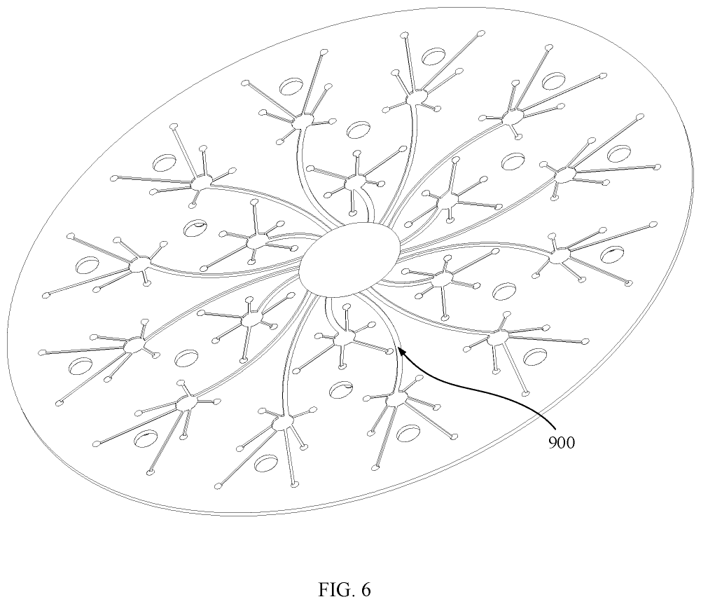

In an exemplary embodiment, referring to FIG. 4, FIG. 6 and FIG. 7 together, multiple liquid outlet flow channels 200 are provided, and the multiple liquid outlet flow channels 200 are provided around the protrusion part 30. Because the protrusion part 30 is disposed opposite to the liquid discharge opening 101, the liquid can uniformly enter each liquid outlet flow channel 200 after driving the protrusion part 30 to undergo elastic deformation, thus providing the possibility for the liquid outlet device to uniformly discharge liquid subsequently. Multiple liquid outlet openings 300 are provided, and each liquid outlet flow channel 200 is communicated with at least one liquid outlet opening 300, so as to increase the liquid outlet area of the liquid outlet device and make the liquid discharge of the liquid outlet device softer and more uniform.

In an exemplary embodiment, referring to FIG. 4 and FIG. 7 together, a side of the protrusion part 30 facing the liquid discharge opening 101 has a guide surface 31 which is configured to be elastically deformed with the protrusion part 30 to guide the liquid to the liquid outlet flow channel 200. In this way, the arrangement of the guide surface 31 can facilitate the liquid to enter the liquid outlet flow channel 200, thereby guiding the flow direction of the liquid to a certain extent.

In an exemplary embodiment, as shown in FIG. 4, the guide surface 31 is a spherical crown such that a linear seal can be formed between the protrusion part 30 and the outer housing assembly 10. At this time, the top end of the protrusion part 30 is located in the liquid inlet flow channel 100 and seals the liquid discharge opening 101. In an embodiment of the present application, the outer housing assembly 10 is provided with an accommodation groove 500. The remaining portion of the protrusion part 30 is located in the accommodation groove 500, so that through the arrangement of the accommodation groove 500, the accommodation groove 500 plays a limiting and guiding role during the elastic deformation and reset of the protrusion part 30, thus ensuring that the elastic deformation and reset can meet expectations, and further ensuring that the liquid discharge opening 101 and the liquid outlet flow channel 200 can communicate after the protrusion part 30 is elastically deformed, and ensuring that the liquid discharge opening 101 can be sealed after the protrusion part 30 is reset. In addition, in some exemplary embodiments, the protrusion part 30 may also form a linear seal with a groove opening formed on the outer housing assembly 10 by the accommodation groove 500 to prevent residual liquid in the accommodation groove 500 from entering the liquid outlet flow channel 200.

In another exemplary embodiment, as shown in FIG. 7, the protrusion part 30 includes a circumferential wall 32 and a connection wall 33. The circumferential wall 32 is bent toward the connection wall 33 and connected with a periphery of the connection wall 33 to form a guide surface 31 on a side of the circumferential wall 32 facing away from the connection wall 33. This enables an end face sealing to be formed between the protrusion part 30 and the outer housing assembly 10. At this time, the protrusion part 30 is integrally positioned outside of the liquid inlet flow channel 100 and seals the liquid discharge opening 101. In an embodiment of the present application, the outer housing assembly 10 is provided with an accommodation groove 500. The protrusion part 30 can be integrally located in the accommodation groove 500, so that the accommodating groove 500 plays a limiting and guiding role in the elastic deformation and reset processes of the protrusion part 30 through the arrangement of the accommodating groove 500, ensuring that the clastic deformation and reset can meet expectations, thereby ensuring that the liquid discharge opening 101 and the liquid outlet flow channel 200 can communicate after the protrusion part 30 is elastically deformed, and ensuring that the liquid discharge opening 101 can be sealed after the protrusion part 30 is reset. The liquid acts on the connection wall 33 in order that the circumferential wall 32 bends toward the connection wall 33 so that the guide surface 31 directly faces the liquid discharge opening 101 to guide the liquid to the liquid outlet flow channel 200. The protrusion part 30 can seal by sealing means other than linear sealing and end face sealing.

As shown in FIG. 7, the circumferential wall 32 can be enclosed with the connection wall 33 to form a notch 600 which is disposed opposite to the liquid discharge opening 101. In this way, through the arrangement of the notch 600, the action position of the liquid acting on the protrusion part 30 can be positioned, and the protrusion part 30 can be conveniently elastically deformed according to a preset setting, so that each portion of the circumferential wall 32 can be elastically deformed synchronously, and the fluid can enter the multiple liquid outlet flow channels 200 at the same time, thus improving the liquid outlet effect of the liquid outlet device.

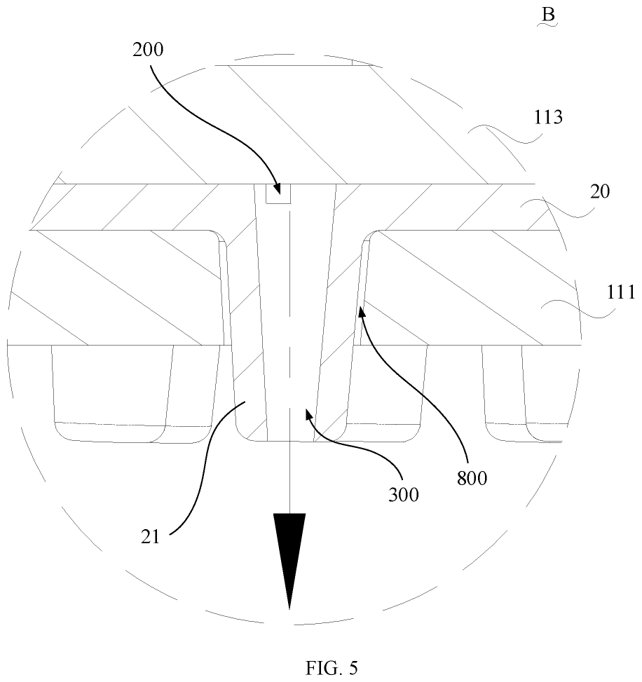

In an exemplary embodiment, in conjunction with FIG. 4, FIG. 5 and FIG. 7 together, the outer housing assembly 10 can clamp and hold the liquid outlet member 20 from a side of the liquid outlet member 20 facing the liquid outlet flow channel 200 and a side of the liquid outlet member 20 facing away from the liquid outlet flow channel 200, and the side of the liquid outlet member 20 facing the liquid outlet flow channel 200 fits with the outer housing assembly 10, thereby improving the sealing of the liquid outlet flow channel 200 and preventing liquid from being discharged from positions other than the liquid outlet opening 300. At the same time, the outer housing assembly 10 can clamp and hold the liquid outlet member 20, and can also ensure that the liquid outlet member 20 keeps a stable position under the impact of liquid, thereby ensuring that a shape of the liquid outlet flow channel 200 remains unchanged, so that the liquid can flow in a preset direction.

The liquid outlet member 20 is made of an elastic material, so that the liquid outlet member 20 can be compressed when clamped and hold by the outer housing assembly 10. When the liquid fills the liquid outlet flow channel 200, the generated liquid pressure can drive the outer housing assembly 10. Although the liquid outlet member 20 can be slightly reset, the liquid outlet member 20 is still in a compressed state, thus ensuring the sealing of the liquid outlet flow channel 200. The liquid outlet member 20 may be made of an elastic material, such as rubber or plastic. The liquid outlet member 20 and the protrusion part 30 can be made of a same elastic material or different elastic materials. The liquid outlet member 20 and the protrusion part 30 can be integrally molded, or can be connected into a whole by secondary processing in the later stage, so as to improve the position stability of the protrusion part 30. In addition, in some embodiments, the liquid outlet member 20 and the protrusion part 30 may also be connected in a detachable manner to facilitate the replacement of the type of the protrusion part 30 and/or the liquid outlet member 20.

In an embodiment of the present application, as shown in FIGS. 1-5 and FIG. 7, the body 11 includes a face cover 111, a rear housing 112 and an inner bracket 113. The face cover 111 is enclosed with the rear housing 112 to form a mounting space 700, the inner bracket 113 and the liquid outlet member 20 are mounted in the mounting space 700. The inner bracket 113 is connected with the rear housing 112, and the liquid outlet member 20 can be abutted against the face cover 111, so that the inner bracket 113 and the face cover 111 can clamp and hold the liquid outlet member 20. A mounting hole 800 is provided on the face cover 111, and a liquid outlet part 21 is provided on the liquid outlet member 20, and the liquid outlet part 21 is penetrated through the mounting hole 800 so that the liquid outlet member 20 and the face cover 111 are positioned. The liquid outlet opening 300 penetrates through the liquid outlet part 21.

In an exemplary embodiment, at least one of the outer housing assembly 10 and the liquid outlet member 20 has a liquid guide groove 900 such that the outer housing assembly 10 is enclosed with the liquid outlet member 20 to form a liquid outlet flow channel 200. In an embodiment of the present application, as shown in FIGS. 4-7, the liquid guide groove 900 is provided on the liquid outlet member 20. It is understood that in other embodiments the liquid guide groove 900 may also be provided on the outer housing assembly 10. Optionally, both the outer housing assembly 10 and the liquid outlet member 20 are provided with a liquid guide groove 900.

In an exemplary embodiment, as shown in FIG. 6, the liquid outlet flow channel 200 extends at least partially away from a radial direction of the liquid outlet member 20 such that the liquid outlet flow channel 200 can accommodate more residual liquid, further avoiding the discharge of residual liquid from the liquid outlet opening 300.

In the description of the present application, it should be noted that the orientation or position relationships indicated by the terms “upper”, “lower”, “one side”, “the other side”, “one end”, “the other end”, “side”, “relative”, “corners”, “periphery” and “square structure” or the like are based on the orientation or position relationships shown in the drawings, which are only for convenience of describing the present application and simplifying the description, rather than indicating or implying that the structure referred has the specific orientation, or is constructed and operated in the specific orientation, and thus cannot be interpreted as a limitation on the present application.

In the description of the embodiments of the present application, unless otherwise explicitly specified and limited, the terms “connection”, “direct connection”, “indirect connection”, “fixed connection”, “installation” and “assembly” should be understood in a broad sense. For example, it may be a fixed connection, a detachable connection, or an integrated connection. The terms “installation”, “connection” and “fixed connection” may be direct connection, or indirect connection through an intermediate medium, or internal communication between two elements. For those of ordinary skills in the art, the specific meanings of the aforementioned terms in the present application may be understood according to specific situation.

Although implementations disclosed in the present application are described above, the described contents are only implementations adopted for facilitating understanding of the present application, and are not intended to limit the present application. It should be noted that the above embodiments or implementations are exemplary only and not limiting. Therefore, the present disclosure is not limited to what is specifically shown and described herein. Various modifications, substitutions or omissions may be made to the form and details of implementation without departing from the scope of the present disclosure.

What is claimed is:

1. A liquid outlet device comprising:
an outer housing assembly provided with a liquid inlet flow channel, wherein the liquid inlet flow channel is capable of forming a liquid discharge opening on the outer housing assembly; and
a liquid outlet member installed to the outer housing assembly, wherein the outer housing assembly is enclosed with the liquid outlet member to form a liquid outlet flow channel, a liquid outlet opening communicated with the liquid outlet flow channel is provided on the liquid outlet member, and the liquid outlet opening is exposed to the outer housing assembly;
wherein the liquid outlet member is provided with a protrusion part, the outer housing assembly is capable of clamping and holding a circumferential outer side of the protrusion part, and the protrusion part is disposed opposite to the liquid discharge opening and elastically abuts against the outer housing assembly to seal the liquid discharge opening;
the protrusion part is configured to elastically deform when a liquid pressure of the liquid inlet flow channel exceeds a preset value, so that the liquid discharge opening communicates with the liquid outlet flow channel, and the protrusion part is capable of resetting against the liquid pressure less than or equal to the preset value.

2. The liquid outlet device according to claim 1, wherein a cavity is provided on a side of the protrusion part facing away from the liquid discharge opening.

3. The liquid outlet device according to claim 2, wherein the outer housing assembly is provided with an accommodation groove, the liquid outlet flow channel is communicated with the accommodation groove, the protrusion part is at least partially accommodated in the accommodation groove, and the protrusion part is configured to elastically deform when the liquid pressure of the liquid inlet flow channel exceeds the preset value, so that the liquid discharge opening is communicated with the accommodation groove.

4. The liquid outlet device according to claim 3, wherein the protrusion part is at least partially accommodated in the liquid discharge opening.

5. The liquid outlet device according to claim 2, wherein the liquid outlet flow channel is communicated with the cavity.

6. The liquid outlet device according to claim 1, wherein a plurality of liquid outlet flow channels are provided, the plurality of liquid outlet flow channels are provided around the protrusion part, a plurality of liquid outlet openings are provided, and each of the liquid outlet flow channels is communicated at least with one of the liquid outlet openings.

7. The liquid outlet device according to claim 6, wherein a side of the protrusion part facing the liquid discharge opening has a guide surface, and the guide surface is configured to be capable of being elastically deformed with the protrusion part to guide the liquid to the liquid outlet flow channel.

8. The liquid outlet device according to claim 7, wherein the guide surface is a spherical crown.

9. The liquid outlet device according to claim 7, wherein the protrusion part comprises a circumferential wall and a connection wall, the circumferential wall is bent toward the connection wall and is connected to a periphery of the connection wall to form the guide surface on a side of the circumferential wall facing away from the connection wall.

10. The liquid outlet device according to claim 9, wherein the circumferential wall is capable of being enclosed with the connection wall to form a groove, and the groove is disposed opposite to the liquid discharge opening.

11. The liquid outlet device according to claim 6, wherein the liquid outlet member is made of an elastic material, and the outer housing assembly is capable of clamping and holding the liquid outlet member from a side of the liquid outlet member facing the liquid outlet flow channel and a side of the liquid outlet member facing away from the liquid outlet flow channel, and the side of the liquid outlet member facing the liquid outlet flow channel fits with the outer housing assembly.

12. The liquid outlet device according to claim 6, wherein the liquid outlet flow channel extends at least partially away from a radial direction of the liquid outlet member.

13. The liquid outlet device according to claim 2, wherein a plurality of liquid outlet flow channels are provided, the plurality of liquid outlet flow channels are provided around the protrusion part, a plurality of liquid outlet openings are provided, and each of the liquid outlet flow channels is communicated at least with one of the liquid outlet openings.

14. The liquid outlet device according to claim 13, wherein a side of the protrusion part facing the liquid discharge opening has a guide surface, and the guide surface is configured to be capable of being elastically deformed with the protrusion part to guide the liquid to the liquid outlet flow channel.

15. The liquid outlet device according to claim 14, wherein the guide surface is a spherical crown.

16. The liquid outlet device according to claim 14, wherein the protrusion part comprises a circumferential wall and a connection wall, the circumferential wall is bent toward the connection wall and is connected to a periphery of the connection wall to form the guide surface on a side of the circumferential wall facing away from the connection wall.

17. The liquid outlet device according to claim 16, wherein the circumferential wall is capable of being enclosed with the connection wall to form a groove, and the groove is disposed opposite to the liquid discharge opening.

18. The liquid outlet device according to claim 13, wherein the liquid outlet member is made of an elastic material, and the outer housing assembly is capable of clamping and holding the liquid outlet member from a side of the liquid outlet member facing the liquid outlet flow channel and a side of the liquid outlet member facing away from the liquid outlet flow channel, and the side of the liquid outlet member facing the liquid outlet flow channel fits with the outer housing assembly.

19. The liquid outlet device according to claim 13, wherein the liquid outlet flow channel extends at least partially away from a radial direction of the liquid outlet member.

20. A liquid outlet system comprising:
the liquid outlet device according to claim 1; and
a liquid inlet assembly communicated with the liquid inlet flow channel, wherein the liquid inlet assembly is configured to provide liquid to the liquid inlet flow channel.
